(19) United States
(12) Patent Application Publication
(10) Pub. No.: US 2004/0023702 A1
(43) Pub. Date: Feb. 5, 2004

(54) Protection structure used in electronic device with interchangeable housing

(76) Inventors: Long-Jyh Pan, Taipei (TW); Hsiao-Wu Chen, Taoyuan (TW)

Correspondence Address: Michael D. Bednarek, Shaw Pittman LLP, 1650 Tysons Boulevard, McLean, VA, 22102, US

(21) Appl. No.: 10/620,558

(22) Filed: Jul. 17, 2003

(30) Foreign Application Priority Data
Jul. 31, 2002 (TW) 91211708

(51) Int. Cl. H04M 1/00

(52) U.S. Cl. 455/575.8

(57) ABSTRACT

The present invention relates to a protection structure for use with an electronic device having an interchangeable housing. The protection structure includes a first protection element and a second protection element. The first protection element is disposed between an upper cover and an electronic module of the electronic device. The second device is disposed between a lower cover and the electronic module of the electronic device and coupled to the first protection element. When a user disassembles the upper and lower covers, the first and second protection elements protect the electronic module.

This application claims priority of Taiwan Patent Application No.091211708 filed Jul. 31, 2002.

### FIELD OF INVENTION

The present invention relates to a protection structure for use with an electronic device having an interchangeable housing.

### BACKGROUND OF THE INVENTION

In the past few years, the sales of mobile phone have rapidly increased to make it a sunrise product in the market. The appearance of mobile phones is one important factor in the sales volume.

Smaller size and weight of mobile phones are two important considerations when consumers purchase mobile phones. Because mobile phones with smaller size and weight are easier to carry and hold. Additionally, mobile phones having a large-scale display also attract consumers, because information on such mobile phones are easier to be read.

Recently, color and design of the housings of mobile phones are most attractive to young consumers. To satisfy the demands of individualization and diversity of young consumers, some mobile phones use so-called “interchangeable housings”. Consumers can change the interchangeable housings themselves according to their preference of colors and appearances.

However, there exist problems of the interchangeable housings. When consumers disassemble the housings from the mobile phones, inner electronic modules are exposed without protection. Those electronic modules, such as a liquid crystal display (LCD), are precision and brittle. Any careless treatment will seriously damage those electronic modules.

Besides the mobile phones, many other electronic devices, such as personal digital assistants (PDA) and digital cameras, have similar problems. Therefore, protection of the inner electronic modules is an important issue upon designing those products.

### SUMMARY OF THE INVENTION

It is an aspect of the present invention to provide an electronic device having a protection structure for protecting an inner electronic module while changing its housing.

It is another aspect of the present invention to provide a protection structure to protect the electronic module of the electronic device while changing the housing.

The electronic device includes an electronic module and an interchangeable housing. The interchangeable housing includes a separable? upper cover and a lower cover. The upper cover connects with the upper cover to form a first space for accommodating the electronic module.

The protection structure of the present invention includes a first protection element and a second protection element. The first protection element is disposed between the upper cover and the electronic module, and the second protection element is disposed between the lower cover and the electronic module. The first protection element is coupled with the second protection element. The first protection element and the second protection element together form a second space for accommodating the electronic module. When a user intends to change the interchangeable housing, the first protection element and the second protection element are capable of protecting the electronic module.

This and other aspects of the present invention will become clear to those of ordinary skills in the art after having read the following detailed description of the preferred embodiments illustrated in the various figures and drawings.

### BRIEF DESCRIPTION OF THE DRAWINGS

FIG. 1 shows an explosive view of an embodiment of the present invention;

FIG. 2 shows a front view of the embodiment shown in FIG. 1; and

FIG. 3 shows a rear view of the embodiment shown in FIG. 1.

### DETAILED DESCRIPTION

The present invention provides a protection structure for use with an electronic device, which has an interchangeable housing. In a preferred embodiment, the electronic device mentioned above may include a communication device. However, in another embodiment, the electronic device may include a personal digital assistant (PDA), a digital camera, or other similar devices.

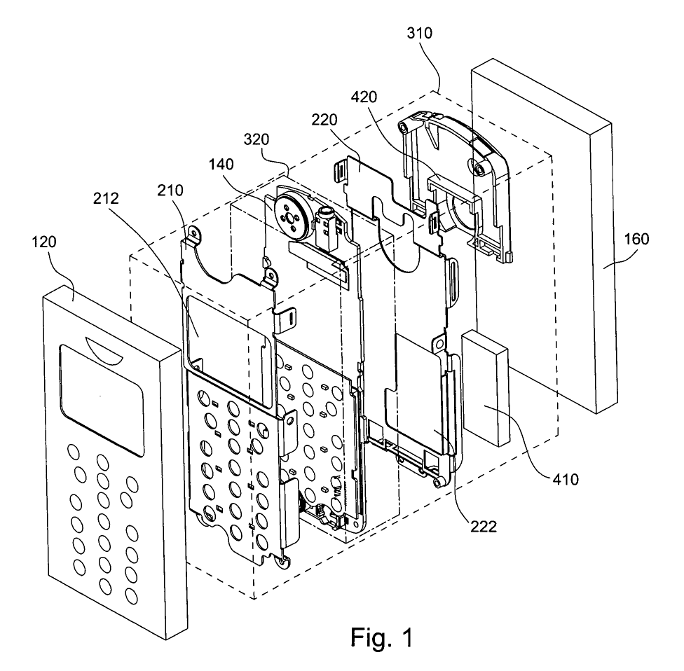

FIG. 1 shows an explosive view of an embodiment of the present invention. The electronic device includes an electronic module 140 and an interchangeable housing.

The interchangeable housing includes an upper cover 120 and a lower cover 160 separably connecting with the upper cover 120. The upper cover 120 and lower cover 160 together form a first space 310 for accommodating the electronic module 140. In a preferred embodiment, the electronic module 140 includes a communication module or a wireless communication module.

The protection structure of the present invention includes a first protection element 210 and a second protection element 220. As FIG. 1 shows, the first protection element 210 is disposed between the upper cover 120 and the electronic module 140, and the second protection element 220 is disposed between the lower cover 160 and the electronic module 140. The first protection element 210 is coupled with the second protection element 220. In a preferred embodiment, the first protection element 210 is separably coupled with the second protection element 220. For example, the first protection element 210 and the second protection element 220 may connect with each other by using screws or latches. However, in another embodiment, the first protection element 210 may be unseparably coupled with the second protection element 220, for example, by sealing or gluing.

As FIG. 1 shows, the first protection element 210 and the second protection element 220 together form a second space 320 for accommodating the electronic module 140. When a user intends to change the interchangeable housing and disassembles the upper cover 120 from the lower cover 160, the first protection element 210 and the second protection element 220 are capable of protecting the electronic module 140.

As FIG. 1 shows, the second protection element 220 further includes an opening 222. The electronic module 140 connects with an electrical power supply device 410 through the opening 222. In a preferred embodiment, the electrical power supply device 410 includes a battery, which is capable of engaging with the opening 222. However, in other embodiments, the electrical power supply device 410 may include an alternating current power supply, a transformer, or other similar devices.

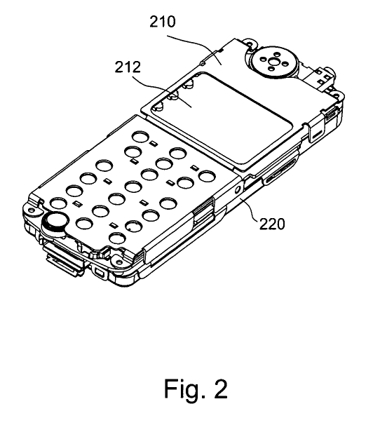

FIG. 2 shows a front view of the embodiment shown in FIG. 1. As FIG. 2 shows, the first protection element 210 further includes a display window 212. A display device, such as a liquid crystal display (LCD), of the electronic module 140 may display information through the display window 212. In addition, the display window 212 may protect the display device while changing the upper cover 120.

The display window 212 may be made of light-permeable materials, such as plastic, acrylic, glass, or other similar materials.

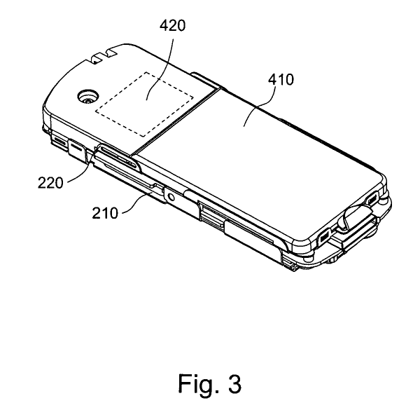

FIG. 3 shows a back view of the embodiment shown in FIG. 1. As FIG. 3 shows, the protection structure further includes an antenna 420, which is disposed on the second protection element 220. In a preferred embodiment, the antenna 420 may be an embedded antenna. However, in other embodiments, the antenna 420 may include a printed antenna, or other similar devices.

The first protection element 210 and the second protection element 220 may be made of various kinds of materials, such as metal, plastic, rubber, or other similar materials. In a preferred embodiment, the first protection element 210 and the second protection element 220 are made of metal. The first and second protection elements 210 and 220, which are made of metal and are capable of providing the electronic device with a shielding effect.

Those skilled in the art will readily observe that numerous modifications and alterations of the device may be made within the teaching of the invention. Accordingly, the above disclosure should be construed as limited only by the metes and bounds of the appended claims.

1. A protection structure for use with an electronic device having an interchangeable housing, said electronic device having an electronic module, said interchangeable housing having an upper cover and a lower cover, said upper cover separably connecting with said lower cover, said upper cover and said lower cover together forming a first space for accommodating said electronic module, said protection structure comprising:
a first protection element disposed between said upper cover and said electronic module; and
a second protection element disposed between said lower cover and said electronic module, and connecting with said first protection element.

2. The protection structure of claim 1, wherein said first protection element includes a display window, said electronic module includes a display device, said display device displays an information through said display window.

3. The protection structure of claim 1, wherein said second protection element includes an opening, said electronic device connects with an electrical power supply device through said opening.

4. The protection structure of claim 1, wherein said protection structure includes an antenna disposed on said second protection element.

5. The protection structure of claim 1, wherein said first protection element is made of metal materials.

6. The protection structure of claim 1, wherein said second protection element is made of metal materials.

7. The protection structure of claim 6, wherein said second protection element provides said electronic device with a shielding function.

8. A communication device, comprising:
an upper cover;
a lower cover separably connecting with said upper cover for forming a first space;
a first protection element disposed within said first space;
a second protection element disposed between said lower cover and said first protection element and connecting with said first protection element, said first protection element and said second protection element together forming a second space; and
a communication module disposed within said second space;
wherein said first protection element and said second protection element protect said communication module when said upper cover and said lower cover are disassembled.

9. The protection structure of claim 8, wherein said first protection element includes a display window, said electronic module includes a display device, said display device displays an information through said display window.

10. The protection structure of claim 8, wherein said second protection element includes an opening, said electronic device connects with an electrical power supply device through said opening.

11. The protection structure of claim 8, wherein said protection structure includes an antenna disposed on said second protection element.

12. The protection structure of claim 8, wherein said first protection element is made of metal materials.

13. The protection structure of claim 8, wherein said second protection element is made of metal materials.

14. The protection structure of claim 13, wherein said second protection element provides said electronic device with a shielding function.
